(19) United States
(12) Patent Application Publication
(10) Pub. No.: US 2010/0219655 A1
(43) Pub. Date: Sep. 2, 2010

(54) Flip open sun visor

(76) Inventor: John William Rymer, JR., Cumming, GA (US)

Correspondence Address: John W. Rymer Jr., 5925 Polo Drive, Cumming, GA, 30040, US

(21) Appl. No.: 12/657,987

(22) Filed: Feb. 1, 2010

Related U.S. Application Data
(60) Provisional application No. 61/151,235, filed on Feb. 10, 2009.

(51) Int. Cl. B60J 3/02

(52) U.S. Cl. 296/97.8

(57) ABSTRACT

An auxiliary sunvisor comprising of two plastic or hardboard panels, one attached to the permanent vehicle sunvisor with two wide rubber bands or similar material, while the other panel may be flipped to the side via the hinge to allow for the blocking of the sun and glare from the side as well as the front simultaneously. The side panel may be raised, lowered or adjusted as necessary to block the angle of sunlight. The hinge design provides nearly infinite adjustability between the two panels that is not found in previous designs. The cost of manufacturing of this design is the lowest of any design to date. The simple method of attachment allows the sidevisor to attach to the permanent visor of any automobile or truck. When in the open position, the side panel allows for a logo (college, sports team), to be seen by other drivers.

This non-provisional patent application claims benefit of the effective filing date of Provisional patent application No. 61/151,235 filed on Feb. 10, 2009.

### TECHNICAL FIELD

The present invention relates generally to an after market sun visor for a motor vehicle, and, more specifically, to a flip open sun visor that may be attached to the factory installed sun visor of a motor vehicle and flipped open to block sun from both the front and the side of the vehicle. The present invention also relates to a business method of placing logos or messages on side visors for advertising, promotion, or entertainment.

### BACKGROUND OF THE INVENTION

Most motor vehicles today come equipped with sun visors to assist the driver—and usually a front passenger—in blocking direct sunlight from shining into their eyes. Direct sunlight into a driver's eyes obviously poses a safety hazard, and can generally be an annoyance even if vision is not impaired. Fortunately, a driver usually does not need to see upward in order to safely operate a motor vehicle, so means may be employed to block the sunlight coming from above while retaining the driver's necessary lines of sight.

A typical factory installed sun visor is somewhat rectangular in shape and flips down from the ceiling above the driver or front seat passenger. The visor may have some contour in its shape to match the shape of the vehicle interior. The sun visor is usually hinged in some fashion near the top of the windshield, so that it may be flipped downward to block sunlight that is above the driver's sight line.

Since vehicles are always moving in relation to the sun, however, annoying sunlight does not always shine directly in the front windshield of the vehicle. The sun is often located off to the side of the driver or passenger, and can be equally hazardous to a driver's vision from that position. To combat this problem, factory installed sun visors often have a pivoting mechanism so that the visor may be pivoted to block sunlight from the side window.

Such a system is not ideal, though, because the sunlight may be coming from both the front and the side and continue to be an annoyance, particularly to people who are extremely sensitive to light. In addition the movement of the vehicle along the road may keep shifting the position of the car relative to the sun so that a driver would need to continually pivot the sun visor back and forth in order to effectively block the sunlight.

Some more modern vehicles come equipped with means to help combat the need to block the sun from both the front and the side, such as a second, smaller sun visor that may be flipped down in the front after the main visor is pivoted to the side. However, the smaller front visor may not be sufficient to effectively block the sunlight. Also, these more modern variations on the typical sun visor are not designed to be retro-fitted onto older vehicles.

Thus there is a need for an after market motor vehicle sun visor addition that assists in blocking sunlight from both the front windshield and side window of a driver or front seat passenger. The sun visor should be capable of effectively blocking sunlight from both directions, without impeding the necessary lines of sight of the driver. In addition, the visor should preferably be inexpensive and simple to install so that all drivers may easily utilize the device.

In addition to the above requirements of an after-market sun visor, the visor may also be used as a means to personalize a motor vehicle. Cars and trucks today have become personal advertisements for the owner's favorite schools, sports teams, or businesses, or places where the owner may display their own personality through the placement of certain symbols or phrases. Some vehicles have become rolling advertisements for a business. The after-market sun visor of the present invention may also be used as a means to participate in such vehicle personalization.

### SUMMARY OF THE INVENTION

Briefly described, in an exemplary embodiment, the present invention comprises a flip open sun visor comprised of two main panels joined by a hinge. One panel may be secured to the existing sun visor of a motor vehicle, while the other panel may be flipped open via the hinge to assist in blocking sunlight from the side. The flip open visor preferably includes means for releasably securing the two panels together when the visor is closed.

In another embodiment of the invention, the hinge connecting the two panels has a pivoting means, so that the side panel may be raised and lowered as necessary to effectively block the angle of the sunlight.

In still another embodiment of the invention, the side panel has an extension sleeve that may be pulled outward along the side panel to more effectively block the sunlight.

In an alternative embodiment of the invention, the side panel includes a logo or message chosen by the driver to personalize the vehicle.

### BRIEF DESCRIPTION OF THE DRAWINGS

Accordingly, the present disclosure will be understood best through consideration of, and with reference to, the following drawings, viewed in conjunction with the Detailed Description of the Invention referring thereto, in which like reference numbers throughout the various drawings designate like structure, and in which:

FIG. 1 is a view of a motor vehicle with the flip open sun visor of the present invention installed and in use.

FIG. 2 is a perspective view of the flip open sun visor of the present invention illustrating how it would typically be utilized.

FIG. 3 is an exterior view of the flip open sun visor of the present invention showing the visor fully opened.

FIG. 4 is a side view of the flip open sun visor of the present invention showing the visor fully opened.

FIG. 5 is an interior view of the flip open sun visor of the present invention showing the visor fully opened.

It is to be noted the drawings presented are intended solely for the purpose of illustration and they are, therefore, neither desired nor intended to limit the scope of the disclosure to any or all of the exact details of construction shown, except insofar as they may be deemed essential to the claimed invention.

### DETAILED DESCRIPTION OF THE INVENTION

In describing exemplary embodiments of the flip open sun visor of the present disclosure illustrated in the drawings, specific terminology is employed for the sake of clarity. The claimed invention, however, is not intended to be limited to the specific terminology so selected, and it is to be understood that each specific element includes all technical equivalents that operate in a similar manner to accomplish a similar purpose.

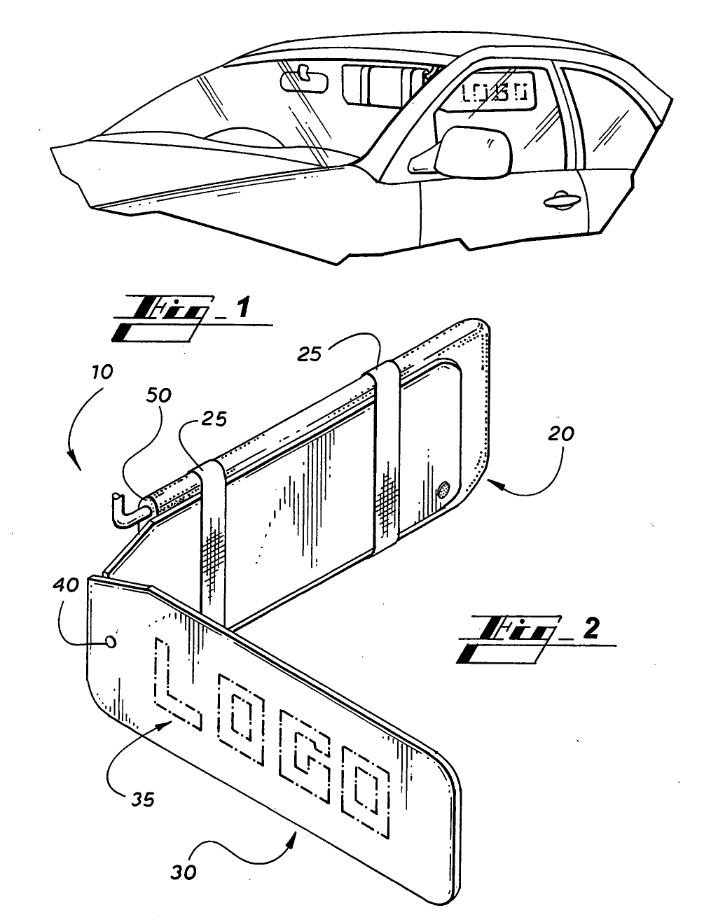

In that form of the flip open sun visor of the present disclosure chosen for purposes of illustration, FIG. 2 shows an exemplary sun visor device 10 embodying the present invention. In this embodiment, sun visor 10 comprises two halves 20 and 30 joined together at hinge 40. The first half 20 of sun visor 10, also referenced herein as the base, may be secured to the existing, factory installed sun visor 50. As such, base 20 preferably has substantially the same shape as original visor 50. The second half 30 of the flip open sun visor 10, also referenced herein as the side visor, may be attached to base 20 via some sort of hinge 40 to allow side visor 30 to extend out to about a 90 degree angle from base 20, or even further open. In this embodiment, the main visor 10 may be flipped down to provide protection from sunlight in the forward direction, and then side visor 30 may be flipped to the side to provide protection from sunlight on the side of the vehicle, as illustrated in FIG. 1.

In one preferred embodiment of this invention, flip open sun visor 10 is reversible so that it also may be used by a front seat passenger. To reverse flip open sun visor 10 one preferably changes the roles of the two halves, so that side visor 30 becomes the base, and base 20 becomes the side visor. Alternatively, one could turn the flip open sun visor 10 upside down, but if the two halves have been shaped to match the contour of the factory visor 50, then this type of inversion would not be preferred.

Turning back to FIG. 2, base 20 is preferably removably secured to original visor 50. Many possible means for this attachment may be employed, such as the use of elastic bands 25. The elastic band attachment is preferable, as this provides for easy installation and removal without the use of any equipment whatever. To utilize the flip open visor, one merely lowers factory visor 50 which provides access to sun visor 10, at which point side visor 30 may be flipped open toward the window. To replace the visor, side visor 30 is first closed, and then the factory visor 50 is flipped back up.

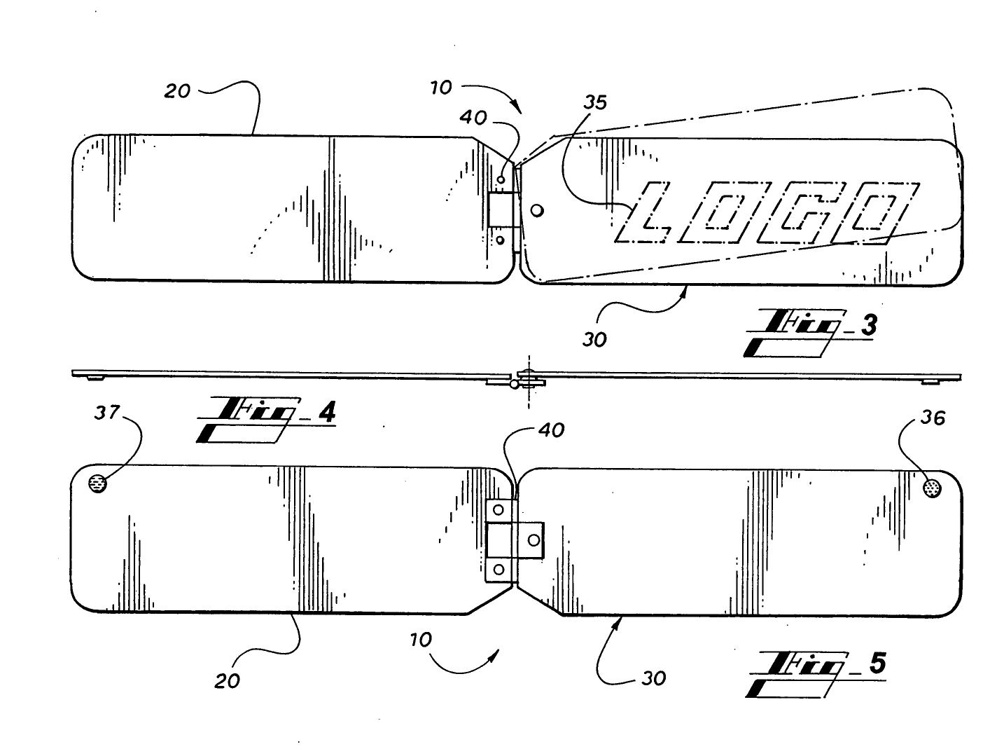

Turning now to FIGS. 3-5, further detail of one embodiment of the present invention is shown. Any suitable hinge system to connect base 20 with visor 30 should be acceptable. As shown in FIG. 3, hinge 40 preferably has a pivotal means, such that side visor 30 may be tilted up and down slightly to adjust for different angles of the sun.

In another embodiment of the present invention, not shown, side visor 30 may include an extension means to so that the visor may be extended lengthwise to provide further sun protection. Several well-known means for extending the visor may be utilized, such as providing an exterior sleeve portion in slideable engagement with side visor 30.

As shown in FIG. 5, the interior portion of sun visor 10 preferably has means to releasably secure the two halves, 20 and 30, whenever the visor is closed. Any suitable means may be used, such as a hook and loop connection as used with VELCRO® attachment strips 36, 37. This attachment means will deter the side visor from attempting to open when it is stored away, otherwise flip open sun visor 10 may cause the factory visor 50 to drop down unexpectedly.

Flip open sun visor 10 may be constructed of any usable material that is stiff enough to hold its shape, and durable enough to withstand being used on a regular basis. The preferred material is some sort of thin, rigid plastic, but many other possible materials may be used. As shown in FIG. 4, the material used to construct flip open visor 10 is preferably quite thin, as it needs to have the ability to fit behind the factory visor 50 in the folded up position, even when closed. If the material is too thick, then the factory visor 50 probably will not close correctly.

Another feature of the present invention is the use of flip open sun visor 10 to personalize the motor vehicle by displaying a selected message 35, illustrated as “LOGO” in the figures. This message could be virtually anything, such as sports team or school logos, business logos, bumper sticker style messages, messages directed at other drives, changeable messages via white board or magnetic attachment, and the like. Such use of side visor 10 to display messages on side windows of cars provides a unique opportunity to associate a message directly with the driver or passenger of the car. The message 35 may preferably be printed on both halves of flip open side visor 10, so that the device may be used by either driver or passenger and still display the message out of the side window.

One skilled in the art will readily recognize the many advantages provided by the flip open sun visor 10 herein described. The device is easily installed by a user, and immediately provides twice the ability to block sunlight. Many users will be happy to display the personalized messages out of their side window as well. Further, the device is easily transferred from one car to the next, so that a driver could take the visor along even if he will be travelling in an unfamiliar vehicle.

Having thus described exemplary embodiments of the present invention, it should be noted by those skilled in the art that the disclosures herein are exemplary only and various other alternatives, adaptations, and modifications may be made within the scope and spirit of the present invention. Accordingly, the present invention is not limited to the specific embodiments as illustrated herein, but is only limited by the following claims.

What is claimed is at least:

1. A flip open sun visor for a motor vehicle having a standard flip down front sun visor, comprising:
a. A base, shaped to match the contour of a standard motor vehicle sun visor;
b. A side visor hingably attached to said base; and
c. Means for securing said base to said standard motor vehicle sun visor.
d. The primary panel attaches to the permanent visor by way of two rubber bands or anything similar. It is 14 inches in length and six inches in width. This size can be changed according to size of permanent visor in vehicle. The primary panel can be viewed on FIGS. 2 and 5.

2. A method of communicating an idea comprising:
a. Providing an attachment for a standard flip down front sun visor of a motor vehicle, said attachment providing a side visor that may be opened toward a side window of the vehicle while the standard visor is facing the front; and
b. Printing said idea on said side visor so that it may be viewed from the exterior of the car.

3. The manufacturing cost of invention is significantly lower than previous designs allowing more people the opportunity to own a side visor where the sun and glare can be shielded from both the front and side of a vehicle at the same time. This offers better safety, eye protection and skin protection from sun while driving.
